(19) United States
(12) Patent Application Publication
(10) Pub. No.: US 2002/0126581 A1
(43) Pub. Date: Sep. 12, 2002

(54) Method of analyzing clock skew between signals

(76) Inventor: Masahito Endo, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/052,512

(22) Filed: Jan. 23, 2002

(30) Foreign Application Priority Data
Mar. 6, 2001 (JP) 2001-62322

(51) Int. Cl. G04B 47/02

(52) U.S. Cl. 368/13

(57) ABSTRACT

To prevent circuit elements of a semiconductor circuit from being erroneously operated, a simulation of operations of the circuit elements is performed when the designed semiconductor circuit is designed. In this simulation, an event (or a change of a signal value) is initially given to each of a plurality of external input pins of the designed semiconductor circuit, and the event of each external input pin is serially propagated circuit elements serially connected with each other with the passage of time. Therefore, an event occurs at a time in each circuit element. A clock skew between events of each pair of circuit elements is analyzed according to connection information and delay information of the circuit elements, and external input pin information of each external input pin is attached to the events occurring in the circuit elements in which the event of the external input pin is propagated. In cases where a clock skew of a pair of events extraordinarily differ from that indicated by a clock skew analysis specification on condition that the external input pin information attached to one event is the same as that attached to the other event, it is judged that a clock skew error occurs. Therefore, the outputting of a report erroneously indicating the occurrence of a clock skew error is reduced.

### BACKGROUND OF THE INVENTION

1. Field of the Invention

The present invention relates to a method of analyzing a time difference (generally called a clock skew) between changes of signal values of each pair of clock signals, which are transmitted through signal lines of a semiconductor integrated circuit, in the design of the semiconductor integrated circuit to detect an extraordinary time difference (hereinafter, called a clock skew error) which causes an erroneous operation of the semiconductor integrated circuit.

2. Description of Related Art

To analyze a clock skew between clock signals transmitted through each pair of clock signal lines in the design of a semiconductor integrated circuit, an event driven type logic simulator having a function of analyzing a clock skew between changes of values of clock signals transmitted through each pair of clock signal lines has been used. In this logic simulator, a gate level net list denoting connection information of logic elements (for example, AND gate) and storage elements (for example, flip-flop) is prepared, a change of each signal value (hereinafter called an event) is simulated with the passage of time according to the gate level net list, and a clock skew between events of each pair of signals is estimated.

FIG. 6 is a timing chart showing waveforms of signals transmitted through a pair of clock signal lines referred for clock skew analysis by using a conventional logic simulator.

In FIG. 6, CLK1 and CLK2 indicate signal lines of a pair of clock signals in a semiconductor circuit. Numerals 100, 102, 200 and 202 indicate times set in the conventional logic simulator. A waveform of a clock signal transmitted through the signal line CLK1 and a waveform of a clock signal transmitted through the signal line CLK2 are shown. In this logic simulator, a change (hereinafter, called “0→1” event) from an L level to an H level occurring at a first time in a clock signal transmitted through the signal line CLK1 is detected, a “0→1” event occurring at a second time in a clock signal transmitted through the signal line CLK2 is detected, and a condition for the judgment on a clock skew error is satisfied in cases where a time difference between the first time and the second time is larger than a prescribed threshold value. That is, in cases where a time difference between the first time and the second time is larger than a prescribed threshold value, because a clock skew error causing an erroneous operation of the semiconductor circuit occurs between the signal lines CLK1 and CLK2, it is judged in the conventional logic simulator that a clock skew error occurs in the semiconductor circuit. Therefore, in the simulation of the conventional logic simulator, events of the signals are checked with the passage of time. When a clock skew (time difference) between a “0→1” event occurring in the clock signal transmitted through the signal line CLK1 and a “0→1” event occurring in the clock signal transmitted through the signal line CLK2 is larger than a prescribed threshold value, it is judged that a clock skew error occurs in the conventional logic simulator, and a report indicating the occurrence of a clock skew error is output.

However, no correspondence of events (for example, “0→1” events) of the signal line CLK1 to events (for example, “0→1” events) of the signal line CLK2 is determined in the conventional logic simulator. Therefore, in the conventional logic simulator, there is a probability that a pair of events having no relation to the operation of the semiconductor circuit is erroneously selected. In this case, a judgment on a clock skew error is performed for a clock skew (or a time difference) between the pair of events, and a clock skew error is erroneously detected. Therefore, a problem has arisen that a report erroneously indicating the occurrence of a clock skew error is output.

For example, as shown in FIG. 6, the judgment for a clock skew (or a time difference) between a “0→1” event of a time 100 in the signal line CLK1 and a event of a “0→1” time 102 in the signal line CLK2 is desired. However, a “0→1” event of a time 102 in the signal line CLK2 is referred for the judgment, a “0→1” event of a time 200 in the signal line CLK1 is referred for the judgment, and the judgment for a clock skew (time difference) between the “0→1” event of the time 102 in the signal line CLK2 and the “0→1” event of the time 200 in the signal line CLK1 is erroneously performed. Therefore, even though a clock skew (time difference) between the “0→1” event of the time 100 in the signal line CLK1 and the “0→1” event of the time 102 in the signal line CLK2 is lower than a prescribed threshold value, because a clock skew (time difference) between the “0→1” event of the time 102 in the signal line CLK2 and the “0→1” event of the time 200 in the signal line CLK1 is extraordinarily higher than a prescribed threshold value, it is erroneously judged that a clock skew error occurs in the signal lines CLK1 and CLK2, and a report erroneously indicating the occurrence of a clock skew error is output.

### SUMMARY OF THE INVENTION

An object of the present invention is to provide, with due consideration to the drawbacks of a clock skew analyzing method performed in the conventional logic simulator, a method of analyzing a clock skew between signals in which the outputting of a report erroneously indicating the occurrence of a clock skew error is reduced.

The object is achieved by the provision of a method of analyzing a clock skew, comprising the steps of receiving connection information indicating a connection relationship among a plurality of circuit elements of a designed circuit, receiving delay information indicating delay times of signals in the circuit elements, receiving clock skew analysis specification expressing constraints on clock skews among a plurality of events of the signals, simulating an operation of the designed circuit according to the connection information and the delay information by giving events to a plurality of external input pins of the designed circuit respectively as initial conditions and serially propagating the event occurring in each external input pin to a plurality of circuit elements, which are connected with the external input pin and are serially connected with each other, with the passage of time, attaching identification information indicating each external input pin to the circuit elements, to which the event given to the external input pin is propagated, as attribute data, obtaining a clock skew analysis by analyzing a clock skew between a pair of events propagated to each pair of analyzed circuit elements of which operations are analyzed, obtaining an identification information judgment by judging whether or not the identification information of the event propagated to each analyzed circuit element is the same as that attached to the event propagated to another analyzed circuit element in cases where the clock skew between the events is analyzed in the step of obtaining the clock skew analysis, and judging whether or not a clock skew error occurs in each analyzed circuit element according to the clock skew analyses relating to the analyzed circuit element, the identification information judgments relating to the analyzed circuit element and the clock skew analysis specification.

In the above steps, when the judgment on a clock skew error is performed, not only a clock skew between each pair of events is analyzed, but also it is required that the identification information attached to one event is the same as the identification information attached to the other event. Therefore, it is prevented that a pair of events having no relation to the operation of the designed circuit is erroneously selected for the analysis of the clock skew.

Accordingly, the outputting of a report erroneously indicating the occurrence of a clock skew error can be reduced, a time required for the clock skew analysis relating to the clock skew error can be shortened, and a design work can be efficiently performed.

It is preferred that the step of judging whether or not a clock skew error occurs comprises the steps of obtaining a clock skew judgment by judging whether or not the clock skew analyzed in the step of obtaining the clock skew analysis is higher than a prescribed lower limit and is lower than a prescribed upper limit, and judging whether or not a clock skew error occurs in each analyzed circuit element according to the clock skew judgments relating to the analyzed circuit element, the identification information judgments relating to the analyzed circuit element and the clock skew analysis specification.

In the above steps, a judgment condition on the clock skew of events is stricter than a case where the clock skew of events is compared with a prescribed check value. Therefore, the number of combinations of two events satisfying the judgment condition on the clock skew of events is reduced. Because it is not required to perform the identification information judgment for each pair of events which do not satisfy the judgment condition on the clock skew, the clock skew analysis relating to the clock skew error can be performed at high speed.

It is also preferred that the step of simulating the operation of the designed circuit comprises the steps of:

setting one circuit element, of which the operation is analyzed, as an analyzed circuit element, detecting that one circuit element or a plurality of circuit elements are placed on a signal transmission line by tracing backward the signal transmission line from the analyzed circuit element to the corresponding external input pin, and attaching distinguishing information to the circuit elements placed on the signal transmission line. Also, the step of attaching the identification information includes a step of attaching the identification information to the circuit elements, to which the distinguishing information is attached, as attribute data.

In the above steps, because it is not required to attach the identification information to each circuit element no placed on the signal transmission line, a volume of processed data required for the clock skew analysis relating to the clock skew error can be reduced. Accordingly, the clock skew analysis relating to the clock skew error can be performed at high speed.

It is also preferred that the step of simulating the operation of the designed circuit comprises the steps of:

giving auxiliary events to all the circuit elements or a part of the circuit elements respectively as initial conditions, and serially propagating the auxiliary event given to each circuit element to other circuit elements, which are connected with the circuit element and are serially connected with each other, with the passage of time in cases where no event given to the external input pin is propagated to the circuit element.

In the above steps, even though no event given to the external input pin is propagated to a circuit element, because an auxiliary event is given to the circuit element as an initial condition, the auxiliary event occurs in the circuit element, and the auxiliary event can be propagated to other circuit elements.

Accordingly, the clock skew analysis relating to the clock skew can be reliably performed.

It is also preferred that the method of analyzing a clock skew further comprises obtaining an event type judgment by judging whether or not a type of the event propagated to each analyzed circuit element is the same as that attached to the event propagated to another analyzed circuit element in cases where the clock skew between the events is analyzed in the step of obtaining the clock skew analysis. Also, the step of judging whether or not a clock skew error occurs includes a step of judging whether or not a clock skew error occurs in each analyzed circuit element according to the clock skew analyses relating to the analyzed circuit element, the identification information judgments relating to the analyzed circuit element, the event type judgment relating to the analyzed circuit element and the clock skew analysis specification.

In the above steps, it is additionally judged whether or not a type of one of a pair of events is the same as a type of the other event, and the judgment on the clock skew error is performed according to the event type judgment in addition to the clock skew analyses, the identification information judgments and the clock skew analysis specification.

Accordingly, the outputting of a report erroneously indicating the occurrence of a clock skew error can be reliably reduced.

The object is also achieved by the provision of a method of analyzing a clock skew, comprising the steps of receiving connection information indicating a connection relationship among a plurality of circuit elements of a designed circuit, receiving delay information indicating delay times of signals in the circuit elements, receiving clock skew analysis specification expressing constraints on clock skews among a plurality of events of the signals, simulating an operation of the designed circuit according to the connection information and the delay information by giving events to a plurality of external input pins of the designed circuit respectively as initial conditions and serially propagating the event occurring in each external input pin to a plurality of circuit elements, which are connected with the external input pin and are serially connected with each other, through a transmission path with the passage of time, obtaining a transmission path analysis by analyzing whether or not the transmission paths connected with the external input pins respectively are separated from each other, obtaining a clock skew analysis by analyzing a clock skew between a pair of events propagated to each pair of circuit elements of which operations are analyzed, and judging whether or not a clock skew error occurs in each circuit element, of which an operation is analyzed, according to the clock skew analyses relating to the circuit element, the transmission path analysis and the clock skew analysis specification.

In the above steps, it is judged whether or not a plurality of signal transmission paths, through which a plurality of clock signals are respectively transmitted from the external input pins to the circuit elements, are separated from each other. In cases where it is ascertained that the transmission paths are separated from each other, the judgment on a clock skew error is performed without using any identification information judgment. Therefore, it is not required to perform a process for attaching identification information indicating each external input pin to the circuit elements, to which the event given to the external input pin is propagated, as attribute data. Therefore, a volume of processed data required for the clock skew analysis relating to the clock skew error can be reduced.

Accordingly, the clock skew analysis relating to the clock skew error can be performed at high speed, and the outputting of a report erroneously indicating the occurrence of a clock skew error can be reduced.

It is preferred that the method of analyzing a clock skew further comprises obtaining an event type judgment by judging whether or not a type of the event propagated to each circuit element, of which an operation is analyzed, is the same as that attached to the event propagated to another circuit element, of which an operation is analyzed, in cases where the clock skew between the events is analyzed in the step of obtaining the clock skew analysis. Also, the step of judging whether or not a clock skew error occurs includes a step of judging whether or not a clock skew error occurs in each circuit element, of which an operation is analyzed, according to the clock skew analyses relating to the circuit element, the identification information judgments relating to the circuit element, the event type judgment relating to the circuit element and the clock skew analysis specification.

In the above steps, it is additionally judged whether or not a type of one of a pair of events is the same as a type of the other event, and the judgment on the clock skew error is performed according to the event type judgment in addition to the clock skew analyses and the clock skew analysis specification.

Accordingly, the outputting of a report erroneously indicating the occurrence of a clock skew error can be reliably reduced.

It is preferred that the step of judging whether or not a clock skew error occurs comprises the steps of obtaining a clock skew judgment by judging whether or not the clock skew in the step of obtaining the clock skew analysis is higher than a prescribed lower limit and is lower than a prescribed upper limit, and judging whether or not a clock skew error occurs in each circuit element, of which an operation is analyzed, according to the clock skew judgments relating to the circuit element, the transmission path analysis and the clock skew analysis specification.

In the above steps, a judgment condition on the clock skew of events is stricter than a case where the clock skew of events is compared with a prescribed check value. Therefore, the number of combinations of two events satisfying the judgment condition on the clock skew of events is reduced, and a process for the event type judgment is reduced.

Accordingly, the clock skew analysis relating to the clock skew error can be performed at high speed.

It is also preferred that the step of simulating the operation of the designed circuit comprises the steps of:

giving auxiliary events to all the circuit elements or a part of the circuit elements respectively as initial conditions, and serially propagating the auxiliary event given to each circuit element to other circuit elements, which are connected with the circuit element and are serially connected with each other, with the passage of time in cases where no event given to the external input pin is propagated to the circuit element.

In the above steps, even though no event given to the external input pin is propagated to a circuit element, because an auxiliary event is given to the circuit element as an initial condition, the auxiliary event occurs in the circuit element, and the auxiliary event can be propagated to other circuit elements.

Accordingly, the clock skew analysis relating to the clock skew can be reliably performed.

### BRIEF DESCRIPTION OF THE DRAWINGS

FIG. 1 is a block diagram showing the configuration of a clock skew analysis system for which a method of analyzing a clock skew between signals is performed according to a first embodiment of the present invention;

FIG. 2 is a flow chart showing a circuit operation simulating process and a clock skew judging process performed in parallel to the circuit operation simulating process;

FIG. 3 shows an example of a circuit for which the judgment on the occurrence of a clock skew error is performed according to a third embodiment;

FIG. 4 shows an example of a clock skew analysis specification applied for a semiconductor circuit;

FIG. 5 shows a plurality of circuit elements for which the analysis of a clock skew of signals is performed according to a fourth embodiment;

FIG. 6 is a timing chart showing waveforms of signals transmitted through a pair of clock signal lines referred for clock skew analysis by using a conventional logic simulator.

### DETAILED DESCRIPTION OF THE PREFERRED EMBODIMENTS

Embodiments of the present invention will now be described with reference to the accompanying drawings.

Embodiment 1

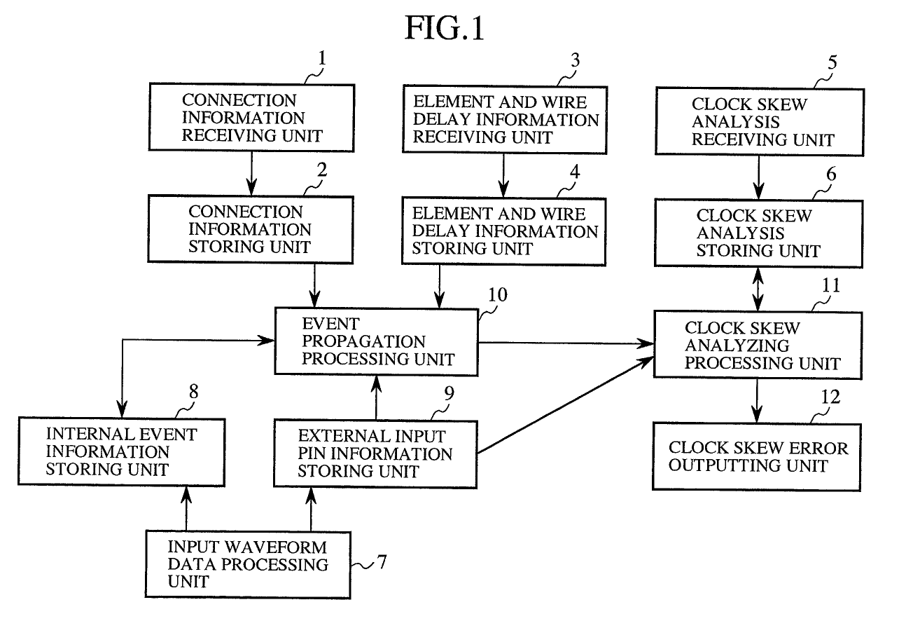

FIG. 1 is a block diagram showing the configuration of a clock skew analysis system for which a method of analyzing a clock skew between signals is performed according to a first embodiment of the present invention.

In FIG. 1, 1 indicates a connection information receiving unit for receiving connection information which indicates the connection of circuit elements composing a designed semiconductor circuit.

2 indicates a connection information storing unit for storing the connection information received in the connection information receiving unit 1.

3 indicates an element and wire delay information receiving unit for receiving delay information indicating delay times occurring in signals transmitted through wires (or signal lines) and the circuit elements of the designed semiconductor circuit.

4 indicates an element and wire delay information storing unit for storing the delay information received in the element and wire delay information receiving unit 3.

5 indicates a clock skew analysis specification receiving unit for receiving a clock skew analysis specification indicating constraints on clock skews (or time differences) among a plurality of events. The constraints are required of the circuit elements to prevent an erroneous operation of the designed semiconductor circuit.

6 indicates a clock skew analysis specification storing unit for storing the clock skew analysis specification received in the clock skew analysis specification receiving unit 5.

7 indicates an input waveform data processing unit for preparing external input pin information (or identification information) according to events given to external input pins of the designed semiconductor circuit as initial conditions to analyze the operation of the designed semiconductor circuit and initially preparing internal event information according to events (or auxiliary events) which are given to all circuit elements or a part of the circuit elements in a prescribed time-period so as to express waveforms of signals in all circuit elements or the part of the circuit elements as initial conditions appropriate to the designed semiconductor circuit.

8 indicates an internal event information storing unit for storing the internal event information prepared in the input waveform data processing unit 7.

9 indicates an external input pin information storing unit for storing the external input pin information prepared in the input waveform data processing unit 7.

10 indicates an event propagation processing unit for propagating each event, which occurs in a circuit element and is specified according to the external input pin information or the internal event information, to another circuit element through a wire according to the connection information of the circuit elements and the delay information of the wire and the circuit elements to newly generate an event, preparing internal event information of the new event and writing the internal event information of the new event in the internal event information storing unit 8 to renew the internal event information stored in the internal event information storing unit 8.

11 indicates a clock skew analyzing unit for detecting an event propagated to a pin of a circuit element referred for clock skew analysis, analyzing a clock skew (or a time difference) between the event propagated to the pin of the circuit element and an event occurring in a pin of each circuit element other than the circuit element referred for clock skew analysis according to the delay information of the wire and the circuit elements, and judging according to the analyzed clock skew (or analyzed time difference) and the clock skew analysis specification whether or not a clock skew error occurs in the designed semiconductor circuit. For example, the clock skew (or time difference) analyzed in the clock skew analyzing unit 11 is extraordinarily higher than a prescribed time difference indicated by the clock skew analysis specification, the judgment on a clock skew error is performed.

12 indicates a clock skew error outputting unit for outputting a report indicating a clock skew error in cases where it is judged in the clock skew analyzing unit 11 that a clock skew error occurs in the designed semiconductor circuit.

Next, various types of information used in the clock skew analysis system are described. Here, because types of data composing each type of information and a data structure for storing the types of data change with a type of logic simulator, each type of information is described as an example.

The clock skew analysis specification is given as a set of pieces of data which systematically express a plurality of circuit elements referred for clock skew analysis, operations of the circuit elements for which a clock skew (or time difference) between signals is analyzed, pins corresponding to the analysis of the clock skew for the operation of each referred circuit element, and a type of event occurring in each pin referred for clock skew analysis.

Waveform data input to the input waveform data processing unit 7 is composed of a set of pieces of data. The set of pieces of data express a name of a signal line corresponding to an event, an event occurrence time and a signal value of the signal line. That is, a plurality of events occur in a plurality of signal lines at different event occurrence times with the passage of time in a prescribed time-period, and a signal line, in which an event has just occurred, is set to a signal value indicating a type of the event.

The internal event information stored in the internal event information storing unit 8 is composed of a set of pieces of data. The set of pieces of data express names of signal lines corresponding to a plurality of events, an event occurrence time of each event, a signal value of each signal line at the event occurrence time and the external input information denoting attribute data. That is, a plurality of events initially given to all the circuit elements or the part of the circuit elements are propagated and occur in a plurality of signal lines at different event occurrence times with the passage of time. Each signal line, in which an event has just occurred, is set to a signal value indicating a type of the event. The external input pin information is included as attribute data in the internal event information to distinguish the events initially given to all the circuit elements or the part of the circuit elements from external input events initially given to the external input pins and causes the event occurring in each signal line.

The external input pin information stored in the external input pin information storing unit 9 is composed of a set of pieces of data. The set of pieces of data express names of a plurality of external input pins to which the external input events are given, an event occurrence time of each external input event and a signal value in each external input pin. That is, a plurality of external input events are initially given to the external input pins, and each external input pin, in which an external input event has just occurred, is set to a signal value indicating a type of the external input event. Here, the type of the event (or the type of the external input event) is specified by the combination of a signal value before a change of a signal and a signal value after the change of the signal and is distinguished by symbols “0→1”, “1→0”, “X→0” and “X→1”.

Next, an operation of the clock skew analysis system will be described below.

In the connection information receiving unit 1, connection information indicating the connection of circuit elements composing a designed semiconductor circuit is received, a data transformation is performed for the connection information to transform the connection information into transformed connection information having a data structure such as a list structure. The transformed connection information having the data structure is possible to be processed in the clock skew analysis system. The transformed connection information is stored in the connection information storing unit 2 as connection information.

In the element and wire delay information receiving unit 3, delay information indicating delay times occurring in signals transmitted through wires (or signal lines) and the circuit elements of the designed semiconductor circuit is received, a data transformation is performed for the delay information to transform the delay information into transformed delay information having a data structure such as a table structure. The transformed delay information having the data structure is possible to be processed in the clock skew analysis system. The transformed delay information is stored in the element and wire delay information storing unit 4 as delay information.

In the clock skew analysis specification receiving unit 5, a clock skew analysis specification indicating constraints on operation timings of circuit elements such as “set up” and “hold” is received. The clock skew analysis specification is set as library data for a circuit element (for example, a flip-flop, a latch or a selector) in which the clock skew analysis is required. The clock skew analysis specification is transformed into a transformed clock skew analysis specification having a data structure such as a list structure or a table structure. The transformed clock skew analysis specification having the data structure is possible to be processed in the clock skew analysis system. The transformed clock skew analysis specification is stored in the clock skew analysis specification storing unit 6 as clock skew analysis specification.

Also, in the clock skew analysis specification receiving unit 5, a clock skew analysis specification is set for input pins and output pins of each circuit element according to the connection information stored in the connection information storing unit 2.

When the reception of the connection information of the circuit elements, the delay information of the circuit elements and wires and the clock skew analysis specification of a circuit element relating to the clock skew analysis is completed, the simulation of the operations of the circuit elements is performed.

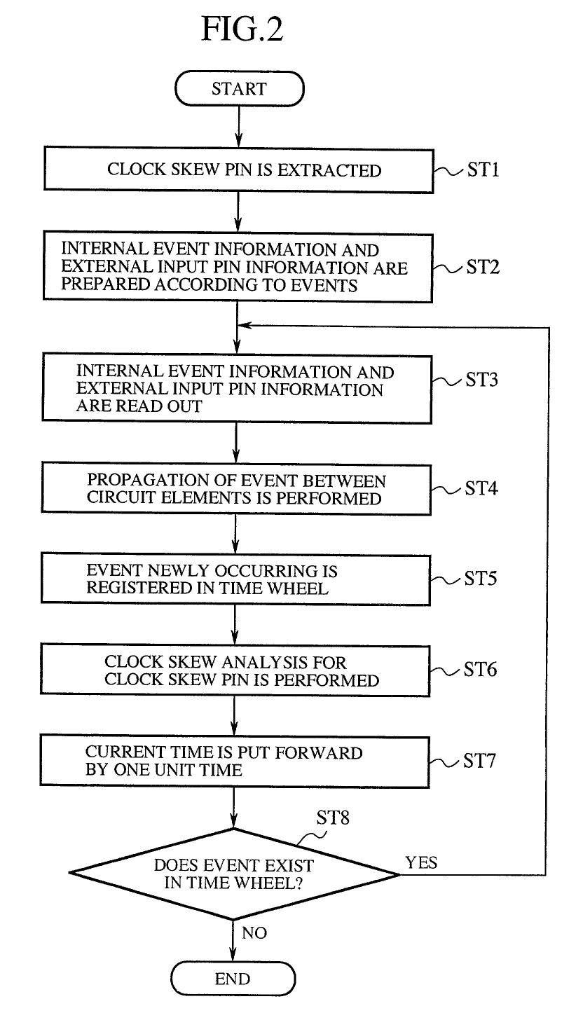

FIG. 2 is a flow chart showing a circuit operation simulating process and a clock skew judging process performed in parallel to the circuit operation simulating process.

In the clock skew analysis specification receiving unit 5, pins (hereinafter, called clock skew pins), in which events are referred, are extracted from each circuit element, in which the clock skew analysis is required, according to a prescribed clock skew analysis specification given to the designed semiconductor circuit (step ST1). Thereafter, the clock skew pins are registered in the clock skew analysis specification storing unit 6. In this case, all clock skew pins are simultaneously extracted, or all clock skew pins are divided into groups of clock skew pins compared with each other in the clock skew analysis to extract each group of clock skew pins.

Thereafter, in the input waveform data processing unit 7, internal event information and external input pin information are prepared to analyze the operation of the designed semiconductor circuit. In detail, to initially give events to all circuit elements or a part of the circuit elements respectively in a prescribed time-period so as to express input waveforms of signals given to all circuit elements or the part of the circuit elements as initial conditions appropriate to the designed semiconductor circuit, internal event information indicating events initially given to all the circuit elements or the part of the circuit elements respectively is prepared. The internal event information is stored in the internal event information storing unit 8 (step ST2). Also, to give external input events to all the external input pins of the designed semiconductor circuit respectively as initial conditions in the simulation of the operations of the circuit elements so as to make the external input events initially occur in the external input pins of the designed semiconductor circuit, external input pin information indicating the external input events given to the external input pins is prepared (step ST2). The external input pin information is stored in the external input pin information storing unit 9.

Here, events occur in the circuit elements of the designed semiconductor circuit with the passage of time due to the events initially given to all the circuit elements or the part of the circuit elements and the external input events initially given to the external input pins, and a set of pieces of data indicate information of the events occurring in the circuit elements of the designed semiconductor circuit with the passage of time. The set of pieces of data has a data structure so as to be possible to extract the events occurring in the circuit elements from the set of pieces of data in time sequence. The set of pieces of data is called a time wheel, and a state of the designed semiconductor circuit at each analyzing time is expressed by the time wheel.

Thereafter, in the event propagation processing unit 10, the internal event information corresponding to an analyzing time (hereinafter, called a current time) is read out from the time wheel stored in the internal event information storing unit 10 (step ST3). Here, a plurality of current times are set one after another with the passage of time to perform the simulation of the operations of the circuit elements at each current time.

Also, in the event propagation processing unit 10, because external input events are initially given to all the external input pins of the designed semiconductor circuit to serially propagate the external input event given to each external input pin to circuit elements serially connected with the external input pin with the passage of time, the external input pin information corresponding to the current time is read out from the external input pin information storing unit 9.

Thereafter, to simulate the operations of the circuit elements, the external input event given to each external input pin is propagated to circuit elements of the designed semiconductor circuit according to the connection information, the delay information and the external input pin information, and an event occurs in both an input pin and an output pin of each circuit element. Also, in cases where no event is propagated from an external input pin to a circuit element, an event occurs in the circuit element according to the internal event information stored in the internal event information storing unit 8.

Thereafter, an event occurring in an output pin of each circuit element at the current time is detected according to the connection information stored in the connection information storing unit 2 and the delay information stored in the element and wire delay information storing unit 4, and the processing for propagating the event to an input pin of another circuit element connected with the output pin is performed according to the delay information and the connection information (step ST4). Thereafter, a new event occurring at a time after the current time in an output pin of the circuit element, in which the event is propagated to the input pin in the step ST4, is detected according to the delay information of the circuit element, and the new event occurring at a time after the current time is registered in the time wheel of the internal event information storing unit 8 to renew the internal event information (step ST5).

Here, in the simulation of the operations of the circuit elements, when an external input event initially given to each external input pin is propagated to an input pin of a circuit element connected with the external input pin, external input pin information identifying the external input pin is attached to an event occurring in the input pin of the circuit element due to the external input event given to the external input pin as attribute data. Also, when a new event occurs in an output pin of each circuit element due to an event propagated to an input pin of the circuit element, external input pin information, which is attached to the event propagated to the input pin of the circuit element as attribute data, is also attached to the new event, which occurs in the output pin of the circuit element as attribute data. Also, when a new event occurs in an input pin of each circuit element due to an event propagated to an output pin of another circuit element connected with the circuit element, external input pin information, which is attached to the event propagated to the output pin of the circuit element as attribute data, is also attached to the new event, which occurs in the input pin of the circuit element as attribute data.

Also, not only a changed signal value of each input pin and a changed signal value of each output pin at the current time are detected and held in the event propagation processing unit 10, but also a not-yet-changed signal value of the input pin and a not-yet-changed signal value of the output pin at a time just before the current time are detected and held as attribute data in the event propagation processing unit 10 to distinguish a type of event (“0→1” event or “1→0” event) in the input pin and a type of event in the output pin.

Thereafter, in the clock skew analyzing unit 11, in cases where each input pin of a circuit element, to which an event newly occurring in another circuit element is propagated at the current time, is set as a clock skew pin, a clock skew analysis of the clock skew is performed for the input pin of the circuit element (step ST6). Here, the input pin, to which an event newly occurring in another circuit element is propagated at the current time, is called a clock skew pin P1. The clock skew pin P1 is included in the clock skew pins extracted in the step ST1 from the circuit element in which the clock skew analysis is required. The clock skew pins other than the clock skew pin P1 are called clock skew pins Px. Also, in each clock skew pin Px, past events referred for clock skew analysis occur at a plurality of past times before the current time, and a latest event among the past events occurs at a past time nearest to the current time. Therefore, an event occurring time of the latest event, a type of the latest event and external input pin information attached to the latest event are attached to each clock skew pin Px as attribute data and are stored in the internal event information storing unit 8 and the external input pin information storing unit 9.

In the processing of the clock skew analysis, a clock skew (or time difference) Tskew between the current time and the event occurring time of the latest event of each clock skew pin Px is calculated for the clock skew pin P1, a type of the latest event of one clock skew pin Px and external input pin information attached to the latest event of the clock skew pin Px are read out from the internal event information storing unit 8 and the external input pin information storing unit 9 for each clock skew pin Px, and the judgment based on following three conditions is performed for each clock skew pin Px.

A first condition C1-1 is that the clock skew (or time difference) Tskew between two events of both the clock skew pin P1 and one clock skew pin Px is higher than a prescribed clock skew checking value Cskew (Tskew<Cskew). A second condition C1-2 is that the external input pin information (a name of an external input pin, an event occurring time and a signal value) attached to the event propagated to the clock skew pin P1 is the same as the external input pin information attached to the latest event occurring in one clock skew pin Px. A third condition C1-3 is that a type of the event propagated to the clock skew pin P1 is the same as a type of the latest event occurring in one clock skew pin Px.

In cases where the second condition C1-2 is satisfied in one clock skew pin Px, it is judged that the external input pin relating to the event occurring in the clock skew pin P1 is the same as the external input pin relating to the event occurring in the clock skew pin Px. Therefore, it is appropriate to select the combination of the clock skew pin P1 and the clock skew pin Px. Also, in cases where the second condition C1-2 and the third condition C1-3 are satisfied in one clock skew pin Px, it is judged that an external input event given to one external input pin is propagated to the clock skew pin Px and the clock skew pin P1 to produce the events in the clock skew pin Px and the clock skew pin P1. Therefore, it is appropriate to analyze a clock skew (or time difference) between the events occurring in the clock skew pin Px and the clock skew pin P1 for the purpose of the simulation relating to a clock skew error. In cases where the first condition C1-1, the second condition C1-2 and the third condition C1-3 are satisfied in one clock skew pin Px, it is judged in the clock skew analyzing unit 11 that a clock skew error occurs in the clock skew pin P1 and clock skew pin Px.

Thereafter, in cases where it is judged in the clock skew analyzing unit 11 that a clock skew error occurs in the clock skew pin P1, a report indicating a clock skew error is output from the clock skew error outputting unit 12. In this case, names of the clock skew pins in which the clock skew error occur, a type of the events referred in the clock skew pins and event occurring times of the events referred in the clock skew pins are output.

Thereafter, the current time is put forward by one unit time (step ST7). Thereafter, the time wheel stored in the internal event information storing unit 8 is referred to detect an event occurring in an output pin of each circuit element at a new current time. In cases where an event exists, the procedure returns to the step ST3 (step ST8). In contrast, in cases where no event exists, the simulation is completed(step ST8).

As is described above, in the first embodiment, in the analysis of the clock skew, it is ascertained whether or not the external input pin information of an event propagated to a clock skew pin at a current time is the same as that of a latest event occurring in an adjacent clock skew pin connected with the clock skew pin at a past time nearest to the current time. Therefore, it is prevented that a pair of events having no relation to the operation of the designed semiconductor circuit is erroneously selected in the clock skew analysis. Accordingly, the outputting of a report erroneously indicating the occurrence of a clock skew error can be reduced, a time period required for the clock skew analysis of a semiconductor circuit can be shortened, and a design work can be efficiently performed.

Also, because it is additionally ascertained whether or not a type of the event propagated to the clock skew pin at the current time is the same as a type of the latest event occurring in the adjacent clock skew pin at the past time nearest to the current time, the outputting of a report erroneously indicating the occurrence of a clock skew error can be further reduced.

Embodiment 2

In a method of analyzing a clock skew of signals according to a second embodiment, to check a clock skew (or time difference) between two events appropriate to be compared with each other, both an upper limit of a check value and a lower limit of the check value are set.

In detail, the judgment for the clock skew pin P1 is performed according to following three conditions in the clock skew analyzing unit 11 for each clock skew pin Px.

A first condition C2-1 is that the clock skew (or time difference) Tskew between two events of both the clock skew pin P1 and one clock skew pin Px is higher than a clock skew lower limit CskewMin and is lower than a clock skew upper limit CskewMax (CskewMin<Tskew<CskewMax). A second condition C2-2 is that the external input pin information (a name of an external input pin, an event occurring time and a signal value) attached to the event propagated to the clock skew pin P1 is the same as the external input pin information attached to the latest event occurring in one clock skew pin Px. A third condition C2-3 is that a type of the event propagated to the clock skew pin P1 is the same as a type of the latest event occurring in one clock skew pin Px.

The second condition C2-2 is the same as the second condition C1-2 of the first embodiment, and the third condition C2-3 is the same as the third condition C1-3 of the first embodiment.

In cases where the second condition C2-2 is satisfied in one clock skew pin Px, it is judged that the external input pin relating to the event occurring in the clock skew pin P1 is the same as the external input pin relating to the event occurring in the clock skew pin Px. Therefore, it is appropriate to select the combination of the clock skew pin P1 and the clock skew pin Px. Also, in cases where the second condition C2-2 and the third condition C2-3 are satisfied in one clock skew pin Px, it is judged that an external input event given to one external input pin is propagated to the clock skew pin Px and the clock skew pin P1 to produce the events in the clock skew pin Px and the clock skew pin P1. Therefore, in cases where the first condition C2-1, the second condition C2-2 and the third condition C2-3 are satisfied in one clock skew pin Px, it is judged in the clock skew analyzing unit 11 that a clock skew error occurs in the clock skew pin P1.

As is described above, in the second embodiment, in the analysis of the clock skew, a clock skew lower limit CskewMin and a clock skew upper limit CskewMax are used to check a clock skew (or time difference) Tskew between two events of both the clock skew pin P1 and one clock skew pin Px. Therefore, in cases where it is apparent that there is no probability that the clock skew (or time difference) Tskew between events of clock signals is equal to or higher than a clock cycle, the clock skew lower limit CskewMin and the clock skew upper limit CskewMax are set so as to satisfy a relationship 0<CskewMin<CskewMax<clock cycle. In this case, when the clock skew (or time difference) Tskew equal to or higher than the clock cycle is detected in the clock skew analyzing unit 11, it is apparent that the combination of two events is not appropriate to analyze a clock skew between the two events, and it is not required to perform the judgment on the second and third conditions for the combination of the two events. Therefore, the number of combinations of two events, for which the judgment on the second and third conditions is performed, can be reduced.

Accordingly, because it is not required to perform the judgment on the second and third conditions for the combination of two events not satisfying the first condition, the analysis of the clock skew can be performed at high speed.

Embodiment 3

In a method of analyzing a clock skew of signals according to a third embodiment, to check a clock skew (or time difference) between two events appropriate to be compared with each other, the comparison of the external input pin information of one event with that of the other event is not performed.

In detail, the judgment for the clock skew pin P1 is performed according to following two conditions in the clock skew analyzing unit 11 for each clock skew pin Px.

A first condition C3-1 is that the clock skew (or time difference) Tskew between two events of both the clock skew pin P1 and one clock skew pin Px is higher than a prescribed clock skew checking value Cskew (Tskew<Cskew). A second condition C3-2 is that a type of the event propagated to the clock skew pin P1 is the same as a type of the latest event occurring in one clock skew pin Px.

The first condition C3-1 is the same as the first condition C1-1 of the first embodiment, and the second condition C3-2 is the same as the third condition C1-3 of the first embodiment.

In cases where the second condition C3-2 is satisfied in one clock skew pin Px, it is judged that an external input event given to one external input pin is propagated to the clock skew pin Px and the clock skew pin P1 to produce the events in the clock skew pin Px and the clock skew pin P1. Therefore, in cases where the first condition C3-1 and the second condition C3-2 are satisfied in at least one clock skew pin Px, it is judged in the clock skew analyzing unit 11 that a clock skew error occurs in the clock skew pin P1.

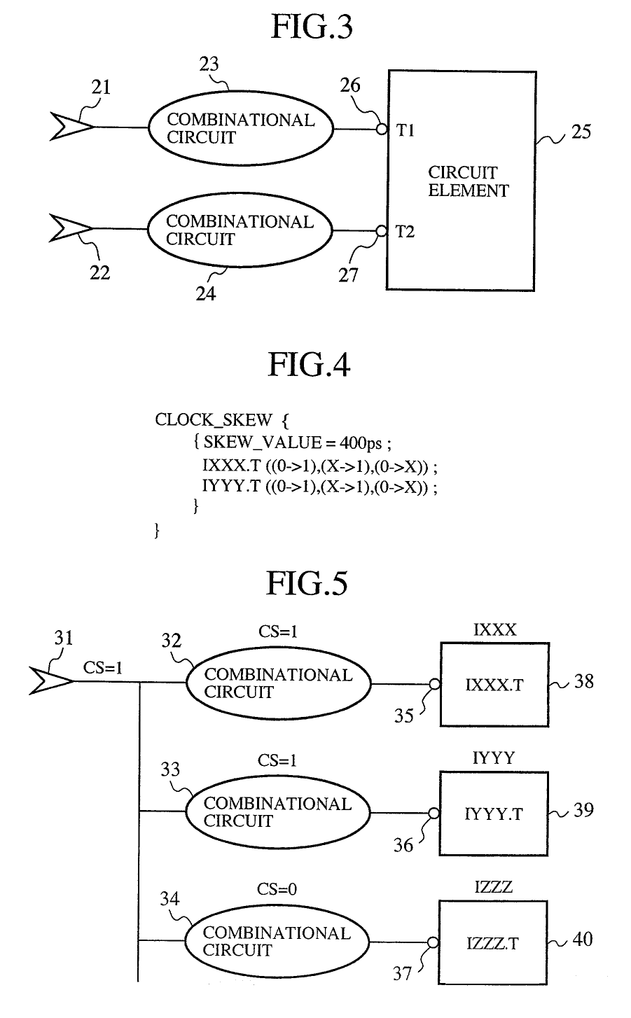

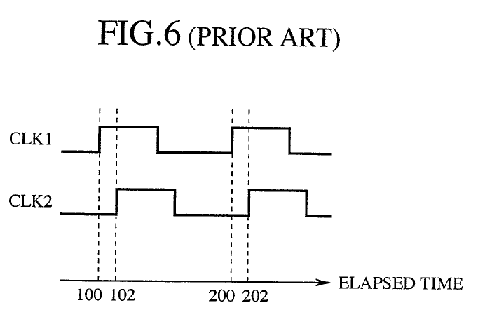

FIG. 3 shows an example of a circuit for which the judgment on the occurrence of a clock skew error is performed according to the first and second conditions C3-1 and C3-2 adopted in the clock skew analyzing method of the third embodiment.

In FIG. 3, 21 and 22 indicate external input pins respectively. 23 indicates a combinational circuit for receiving a clock signal from the external input pin 21. 24 indicates a combinational circuit for receiving a clock signal from the external input pin 22. 25 indicates a circuit element for which a clock skew analysis is required. 26 indicates a clock skew pin for receiving the clock signal from the combinational circuit 23. 27 indicates a clock skew pin for receiving the clock signal from the combinational circuit 24.

As shown in FIG. 3, there are a plurality of clock skew pins for receiving clock signals, and each transmission path of a clock signal from an external input pin to one clock skew pin is separated from the other transmission paths. Therefore, the transmission paths are independent from each other. In this case, the judgment condition C1-2 (or C2-2), in which the external input pin information of the event propagated to the clock skew pin P1 is the same as the external input pin information of the latest event occurring in one clock skew pin Px, is not required.

In detail, there is no probability that the clock signal received in the external input pin 21 is transmitted to the clock skew pin 27, and there is no probability that the clock signal received in the external input pin 22 is transmitted to the clock skew pin 26. Therefore, it is apparent that the external input pin information of an event propagated to the clock skew pin 26 is the same as the external input pin information of a latest event occurring in a clock skew pin of the combinational circuit 23, and it is apparent that the external input pin information of an event propagated to the clock skew pin 27 is the same as the external input pin information of a latest event occurring in a clock skew pin of the combinational circuit 24. Therefore, the judgment condition C1-2 or C2-2 of the first or second embodiment is not required in the third embodiment.

Here, it is required to detect that a clock signal is transmitted from each of a plurality of external input pins to a clock skew pin or a group of clock skew pins through a signal transmission line, and it is required to detect that a plurality of transmission paths, through which a plurality of clock signals are respectively transmitted from a plurality of external input pins to a plurality of clock skew pins, are separated from each other. These detecting processes are performed in an initial step of the simulation of the operations of the circuit elements in the same manner as the extracting process of the clock skew pins.

As is described above, in the third embodiment, it is checked whether or not a plurality of transmission paths, through which a plurality of clock signals are respectively transmitted from a plurality of external input pins to a plurality of clock skew pins, are separated from each other. In cases where it is ascertained that the transmission paths are separated from each other, it is judged without the judgment condition C1-2 or C2-2 whether or not a clock skew error occurs in each clock skew pin. Therefore, the analysis of the clock skew can be performed at high speed. Also, because the process for attaching the external input pin information to each event in the preparation of the internal event information is not required, the simulation of the clock skew can be performed at high speed.

Next, a modification of the third embodiment will be described below.

In cases where an upper limit can be set in a clock skew check value used for a clock skew (or time difference) between two events compared with each other to judge whether or not a clock skew error, the judgment for the clock skew pin P1 is performed according to following two conditions in the clock skew analyzing unit 11 for each clock skew pin Px.

A first condition C3M-1 is that the clock skew (or time difference) Tskew between two events of both the clock skew pin P1 and one clock skew pin Px is higher than a clock skew lower limit CskewMin and is lower than a clock skew upper limit CskewMax (CskewMin<Tskew<CskewMax). A second condition C3M-2 is that a type of the event propagated to the clock skew pin P1 is the same as a type of the latest event occurring in one clock skew pin Px.

The first condition C3M-1 is the same as the first condition C2-1 of the second embodiment, and the second condition C3M-2 is the same as the third condition C1-3 of the first embodiment.

In cases where the second condition C3M-2 is satisfied in one clock skew pin Px, it is judged that an external input event given to one external input pin is propagated to the clock skew pin Px and the clock skew pin P1 to produce the events in the clock skew pin Px and the clock skew pin P1. Therefore, in cases where the first condition C3M-1 and the second condition C3M-2 are satisfied in at least one clock skew pin Px, it is judged in the clock skew analyzing unit 11 that a clock skew error occurs in the clock skew pin P1.

As is described above, in the third embodiment, the number of combinations of two events, for which the judgment on the second condition C3M-2 is performed, can be reduced in the same manner as in the second embodiment. Accordingly, because it is not required to perform the judgment on the second condition C3M-2 for the combination of two events not satisfying the first condition C3M-1, the analysis of the clock skew can be performed at high speed.

Embodiment 4

In a method of analyzing a clock skew of signals according to a fourth embodiment, a plurality of clock skew pins are extracted in the simulation of the operations of the circuit elements, each signal transmission path from a clock skew pin to an external input terminal is traced backward, and a clock skew path flag (or distinguishing information) is put up in each circuit element and signal line (or wire) placed on the signal transmission path traced backward. When an event propagation process is performed between circuit elements in which the clock skew path flag is put up, external input pin information is attached as attribute data to an event occurring in each circuit element in which the clock skew path flag is put up.

Next, an example of the analysis of a clock skew of signals will be described below.

FIG. 4 shows an example of a clock skew analysis specification for a designed semiconductor circuit. In this clock skew analysis specification, a judgment condition on a clock skew error and the procedure for a clock skew error judgment are presented. That is, the clock skew analysis specification indicates that a report indicating the occurrence of a clock skew error is output in cases where a clock skew (or time difference) between an event specified by a signal value change of “0→1”, “X→1” or “0→X” in a clock skew pin T of a circuit element IXXX and an event specified by a signal value change of “0→1”,“X→1” or “0→X” in a clock skew pin T of a circuit element IYYY is higher than a skew check value of 400 ps. Here the symbol “X” indicates that a signal value is set to a logical value “0” or “1”, the symbol “X→1” indicates a first (or rise) transition, and the symbol “0→X” indicates a last (or fall) transition.

FIG. 5 shows a plurality of circuit elements for which the analysis of a clock skew of signals is performed according to the fourth embodiment.

In FIG. 5, 31 indicates an external input terminal. 32, 33 and 34 indicate combinational circuits denoting circuit elements respectively. 35, 36 and 37 respectively indicate input pins for receiving clock signals. 38, 39 and 40 indicate circuit elements respectively.

In cases where the analysis of a clock skew of signals is performed for the circuit elements shown in FIG. 5 according to the clock skew analysis specification showing in FIG. 4, a clock skew path flag attached to each circuit element and signal line is initialized. That is, the clock skew path flag attached to each circuit element and signal line is preset to 0 (CS=0). Thereafter, a transmission path from the clock skew pin 35 to the external input terminal 31 is traced backward, a clock skew path flag of the circuit element 32 and the signal line placed on the transmission path is set to 1 (CS=1). Also, a transmission path from the clock skew pin 36 to the external input terminal 31 is traced backward, a clock skew path flag of the circuit element 33 and the signal line placed on the transmission path is set to 1 (CS=1). Therefore, the circuit elements of a designed semiconductor circuit are classified into a group of circuit elements (CS=1), which are placed on the transmission paths of clock signals input to the clock skew pins, and a group of circuit elements (CS=0), each of which is not placed on the transmission paths of clock signals input to the clock skew pins.

Also, in the propagation process of each event between circuit elements performed during the simulation of the operations of the circuit elements, in cases where a value of the clock skew path flag attached to each circuit element, to which an event is propagated, is set to 1 (CS=1), when an event occurs in the circuit element, a process for attaching external input pin information to the event as attribute data is performed. In contrast, in cases where a value of the clock skew path flag attached to each circuit element, to which an event is propagated, is set to 0 (CS=0), when an event occurs in the circuit element, a process for attaching external input pin information to the event as attribute data is omitted.

As is described above, in the fourth embodiment, each signal transmission path from a clock skew pin to an external input terminal is traced backward, and a clock skew path flag is put up in each circuit element and signal line (or wire) placed on the signal transmission path traced backward. When an event propagation process is performed between circuit elements in which the clock skew path flag is put up, external input pin information is attached as attribute data to the event occurring in each circuit element in which the clock skew path flag is put up. Therefore, a volume of processed data in the event propagation process can be reduced. Accordingly, the simulation of the operations of the circuit elements can be performed at high speed.

What is claimed is:

1. A method of analyzing a clock skew, comprising the steps of:
receiving connection information indicating a connection relationship among a plurality of circuit elements of a designed circuit;
receiving delay information indicating delay times of signals in the circuit elements;
receiving clock skew analysis specification expressing constraints on clock skews among a plurality of events of the signals;
simulating an operation of the designed circuit according to the connection information and the delay information by giving events to a plurality of external input pins of the designed circuit respectively as initial conditions and serially propagating the event occurring in each external input pin to a plurality of circuit elements, which are connected with the external input pin and are serially connected with each other, with the passage of time;
attaching identification information indicating each external input pin to the circuit elements, to which the event given to the external input pin is propagated, as attribute data;
obtaining a clock skew analysis by analyzing a clock skew between a pair of events propagated to each pair of analyzed circuit elements of which operations are analyzed;
obtaining an identification information judgment by judging whether or not the identification information of the event propagated to each analyzed circuit element is the same as that attached to the event propagated to another analyzed circuit element in cases where the clock skew between the events is analyzed in the step of obtaining the clock skew analysis; and
judging whether or not a clock skew error occurs in each analyzed circuit element according to the clock skew analyses relating to the analyzed circuit element, the identification information judgments relating to the analyzed circuit element and the clock skew analysis specification.

2. A method of analyzing a clock skew according to claim 1, wherein the step of judging whether or not a clock skew error occurs comprises the steps of:
obtaining a clock skew judgment by judging whether or not the clock skew analyzed in the step of obtaining the clock skew analysis is higher than a prescribed lower limit and is lower than a prescribed upper limit; and
judging whether or not a clock skew error occurs in each analyzed circuit element according to the clock skew judgments relating to the analyzed circuit element, the identification information judgments relating to the analyzed circuit element and the clock skew analysis specification.

3. A method of analyzing a clock skew according to claim 1, wherein the step of simulating the operation of the designed circuit comprises the steps of:
setting one circuit element, of which the operation is analyzed, as an analyzed circuit element;
detecting that one circuit element or a plurality of circuit elements are placed on a signal transmission line by tracing backward the signal transmission line from the analyzed circuit element to the corresponding external input pin; and
attaching distinguishing information to the circuit elements placed on the signal transmission line, and the step of attaching the identification information includes a step of
attaching the identification information to the circuit elements, to which the distinguishing information is attached, as attribute data.

4. A method of analyzing a clock skew according to claim 1, wherein the step of simulating the operation of the designed circuit comprises the steps of:
giving auxiliary events to all the circuit elements or a part of the circuit elements respectively as initial conditions; and
serially propagating the auxiliary event given to each circuit element to other circuit elements, which are connected with the circuit element and are serially connected with each other, with the passage of time in cases where no event given to the external input pin is propagated to the circuit element.

5. A method of analyzing a clock skew according to claim 1, further comprising:
obtaining an event type judgment by judging whether or not a type of the event propagated to each analyzed circuit element is the same as that attached to the event propagated to another analyzed circuit element in cases where the clock skew between the events is analyzed in the step of obtaining the clock skew analysis, wherein the step of judging whether or not a clock skew error occurs includes a step of
judging whether or not a clock skew error occurs in each analyzed circuit element according to the clock skew analyses relating to the analyzed circuit element, the identification information judgments relating to the analyzed circuit element, the event type judgment relating to the analyzed circuit element and the clock skew analysis specification.

6. A method of analyzing a clock skew, comprising the steps of:
receiving connection information indicating a connection relationship among a plurality of circuit elements of a designed circuit;
receiving delay information indicating delay times of signals in the circuit elements;
receiving clock skew analysis specification expressing constraints on clock skews among a plurality of events of the signals;
simulating an operation of the designed circuit according to the connection information and the delay information by giving events to a plurality of external input pins of the designed circuit respectively as initial conditions and serially propagating the event occurring in each external input pin to a plurality of circuit elements, which are connected with the external input pin and are serially connected with each other, through a transmission path with the passage of time;
obtaining a transmission path analysis by analyzing whether or not the transmission paths connected with the external input pins respectively are separated from each other;
obtaining a clock skew analysis by analyzing a clock skew between a pair of events propagated to each pair of circuit elements of which operations are analyzed; and
judging whether or not a clock skew error occurs in each circuit element, of which an operation is analyzed, according to the clock skew analyses relating to the circuit element, the transmission path analysis and the clock skew analysis specification.

7. A method of analyzing a clock skew according to claim 6, further comprising:
obtaining an event type judgment by judging whether or not a type of the event propagated to each circuit element, of which an operation is analyzed, is the same as that attached to the event propagated to another circuit element, of which an operation is analyzed, in cases where the clock skew between the events is analyzed in the step of obtaining the clock skew analysis,
wherein the step of judging whether or not a clock skew error occurs includes a step of
judging whether or not a clock skew error occurs in each circuit element, of which an operation is analyzed, according to the clock skew analyses relating to the circuit element, the identification information judgments relating to the circuit element, the event type judgment relating to the circuit element and the clock skew analysis specification.

8. A method of analyzing a clock skew according to claim 7, wherein the step of judging whether or not a clock skew error occurs comprises the steps of:
obtaining a clock skew judgment by judging whether or not the clock skew in the step of obtaining the clock skew analysis is higher than a prescribed lower limit and is lower than a prescribed upper limit; and
judging whether or not a clock skew error occurs in each circuit element, of which an operation is analyzed, according to the clock skew judgments relating to the circuit element, the transmission path analysis and the clock skew analysis specification.

9. A method of analyzing a clock skew according to claim 6, wherein the step of simulating the operation of the designed circuit comprises the steps of:
giving auxiliary events to all the circuit elements or a part of the circuit elements respectively as initial conditions; and
serially propagating the auxiliary event given to each circuit element to other circuit elements, which are connected with the circuit element and are serially connected with each other, with the passage of time in cases where no event given to the external input pin is propagated to the circuit element.
